(19) United States
(12) Patent Application Publication
(10) Pub. No.: US 2016/0019490 A1
(43) Pub. Date: Jan. 21, 2016

(54) DERIVATION OF OPERATING ENTITIES AND METRICS FROM COLLABORATION DATA OBTAINED FROM COMPUTING SYSTEMS

(71) Applicant: VoloMetrix, Inc., Seattle, WA (US)

(72) Inventors: Ryan FULLER, Seattle, WA (US); Joel GRUS, Seattle, WA (US); Chantrelle NIELSEN, Seattle, WA (US); Tim CRAIN, Seattle, WA (US); Nikolay TRANDEV, Seattle, WA (US)

(21) Appl. No.: 14/799,877

(22) Filed: Jul. 15, 2015

Related U.S. Application Data
(60) Provisional application No. 62/026,461, filed on Jul. 18, 2014.

(51) Int. Cl. G06Q 10/06; H04L 29/08; G06Q 10/10

(52) U.S. Cl. CPC G06Q 10/06393; G06Q 10/103; H04L 67/22

(57) ABSTRACT

In a method for deriving entities and metrics from collaboration data from a plurality of computing systems, collaboration data is extracted from sent mails and calendars at the plurality of computing systems of a plurality of collaborators. The collaboration data is linked to correspond to one or more entities based on an activity type and collaborator metadata of the collaboration data, linked to organizational metadata defining a structure of an organization, and linked to external entities metadata defining one or more entities outside of the organization. A library of metrics is created for the one or more entities, and the metrics are quantified. The metrics are then displayed on a display, and the metrics are analyzed metrics according to instructions received via the display.

### BACKGROUND OF THE INVENTION

Managers in organizations often have limited visibility into what activities, time investments and other characteristics actually drive business results and are forced to make many decisions blindly or overly biased by a few anecdotes which may not represent what is actually happening. To address this visibility problem, companies will sometimes conduct surveys or interview processes to manually gather data on employee activities and relationships to address similar things. The survey/interview approach of manually gathering data is labor intensive, expensive, results in low quality self-reported data, disrupts the culture and provides only a one-time snapshot which is only marginally useful. More comprehensive analysis of the activities cannot be performed using manual processes while also providing timely results.

### BRIEF SUMMARY OF THE INVENTION

According to one embodiment of the present invention, in a method for deriving entities and metrics from collaboration data from a plurality of computing systems, collaboration data is extracted from sent mails and calendars at the plurality of computing systems of a plurality of collaborators. The collaboration data is linked to correspond to one or more entities based on an activity type and collaborator metadata of the collaboration data, linked to organizational metadata defining a structure of an organization, and linked to external entities metadata defining one or more entities outside of the organization. A library of metrics is created for the one or more entities, and the metrics are quantified. The metrics are then displayed on a display, and the metrics are analyzed according to instructions received via the display.

In one aspect of the present invention, in extracting the sent mails and calendars, collaboration data is mined from the sent mails in the mailboxes and the meetings in the calendars of the plurality of collaborators and stored as a dataset.

In one aspect of the present invention, the following are configured: one or more activity entities for one or more collaboration activities corresponding to the sent mails and the calendars at the plurality of computing systems; one or more person entities corresponding to one or more persons involved in the one or more collaboration activities; and one or more group entities corresponding to the one or more persons involved in the one or more collaboration activities.

In one aspect of the present invention, further configured are one or more connection entities corresponding to one or more connections between persons based on a type and a quantity of the one or more collaboration activities.

In one aspect of the present invention, further configured are one or more network entities corresponding to a collection of connections based on the type and the quantity of the one or more collaboration activities.

In one aspect of the present invention, further configured are one or more process entities corresponding to collaborator engagement in the one or more collaboration activities.

In one aspect of the present invention, the organizational metadata is derived from one or more of the following: an organizational chart, a human resources information system, and a payroll system.

In one aspect of the present invention, prior to creating the metrics, the collaboration data is parsed, and undesired elements are tagged.

In one aspect of the present invention, in tagging the undesired elements, duplicate or overlapping meetings are adjusted, duplicate or overlapping meeting attendees are adjusted; all day, all-week, or recurring meetings are adjusted, and non-meeting appointments are removed.

In one aspect of the present invention, time for the one or more collaboration activities are assigned, and the metrics are quantified using the time assigned to the one or more collaboration activities.

System and computer program products corresponding to the above-summarized methods are also described and claimed herein.

### BRIEF DESCRIPTION OF THE SEVERAL VIEWS OF THE FIGURES

FIG. 1 illustrates a system for deriving entities and metrics from collaboration data according to embodiments of the present invention.

FIG. 2 illustrates a computing system according to embodiments of the present invention.

FIG. 3 illustrates a method for deriving entities and metrics from collaboration data according to embodiments of the present invention.

FIG. 4 is a flowchart illustrating in more detail the extraction of collaboration data from the mails and calendars of the collaborators in the organization, according to embodiments of the present invention.

FIG. 5 illustrates metrics and their descriptions that may be configured for the entities according to embodiments of the present invention.

FIG. 6 is a flowchart illustrating the time allocation method according to embodiments of the present invention.

FIG. 7 is a flowchart illustrating the time spent method according to embodiments of the present invention.

FIG. 8 is a flowchart illustrating a method for determining the push and pull metrics according to embodiments of the present invention.

FIGS. 9A-9F illustrate example displays of the metrics according to embodiments of the present invention.

### DETAILED DESCRIPTION OF THE INVENTION

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Embodiments of the present invention uses collaboration data obtained from computing systems of collaborators and/or from a server. The collaboration data is not self-reported or subject to availability bias, thus providing a more granular picture of how time is allocated to relationships and activities than could be gathered manually. Further, it does this passively with no manual data gathering requirement or imposition on collaborators and can be automated such that the data remains up to date.

The embodiments of the present invention is applied to communications (email, chat, phone calls, etc.) and calendar data from computing systems of collaborators and/or a server, and applied to organizational metadata (structure, performance data, business outcomes, etc.), to generate a set of metrics. Communication, calendar and organizational structure data are used as basic building blocks of a complex network of entities and relationships amongst them. Using these entities and relationships, a library of metrics is built and used in further analyses. The metrics may be displayed via a computing interface, through which parameters of the analysis may be defined and results may be displayed.

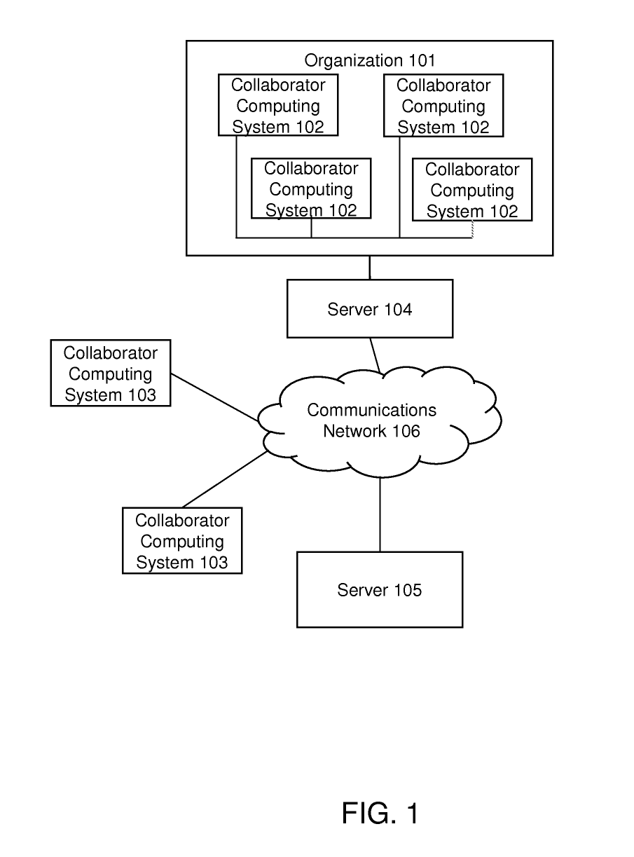

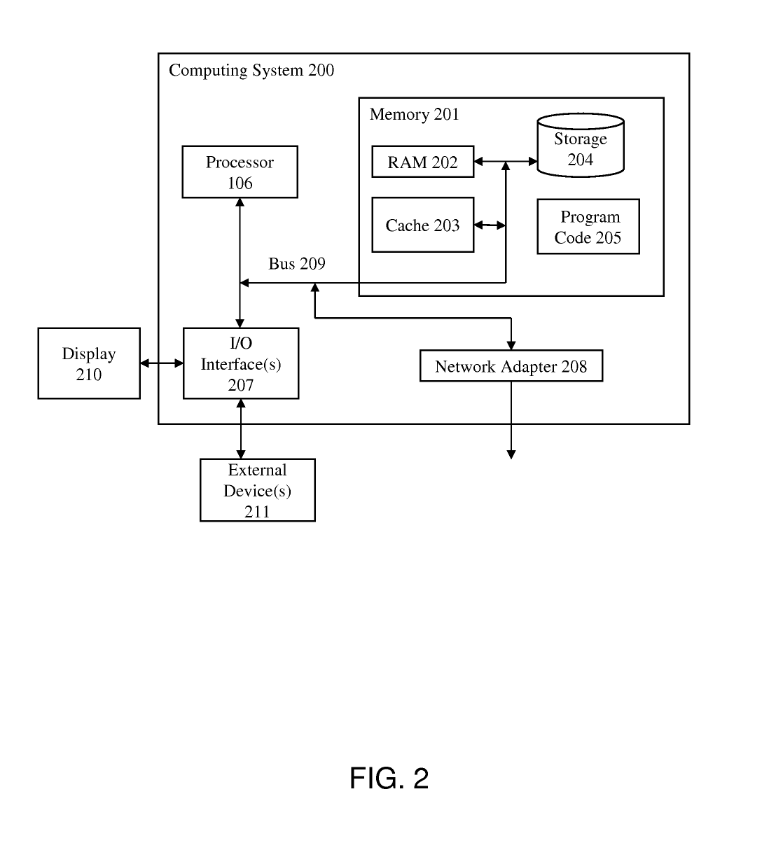

FIG. 1 illustrates a system for deriving entities and metrics from collaboration data according to embodiments of the present invention. The system includes an organization 101, which includes a plurality of internal computing systems 102 of a plurality of internal collaborators (people internal to the organization 101) and a plurality of external computing systems 103 of a plurality of external collaborators (people external to the organization 101). The internal collaborators, via the internal computing systems 102, engage in collaborative activities with each other and/or with persons external to the organization 101, via the external computing systems 103. Some, but not necessarily all, of the collaborative activities may be over a communications network 106, such as the Internet, a cellular network, or virtual private network (VPN). The internal computing systems 102 may collaborate via a server 104 providing certain services, such as e-mail hosting, inter-organizational data sharing, and/or various cloud services. The server 105 provides an assessment service to the organization 101, including allocating time spent on collaborative activities at the internal computing systems 102 for the purpose of deriving entities and metrics used in the assessment service. Any one or more of the internal and external computing system 102 and 103, and the servers 104 and 105, may be a computing system as illustrated in FIG. 2.

FIG. 2 illustrates a computing system according to embodiments of the present invention. The computing system 200 is operationally coupled to a processor or processing units 206, a memory 201, and a bus 209 that couples various system components, including the memory 201 to the processor 206. The bus 209 represents one or more of any of several types of bus structure, including a memory bus or memory controller, a peripheral bus, an accelerated graphics port, and a processor or local bus using any of a variety of bus architectures. The memory 201 may include computer readable media in the form of volatile memory, such as random access memory (RAM) 202 or cache memory 203, or non-volatile storage media 204. The memory 201 may include at least one program product having a set of at least one program code module 205 that are configured to carry out the functions of embodiment of the present invention when executed by the processor 206. The computer system 200 may also communicate with one or more external devices 211, such as a display 210, via I/O interfaces 207. The computing system 200 may communicate with one or more networks via network adapter 208.

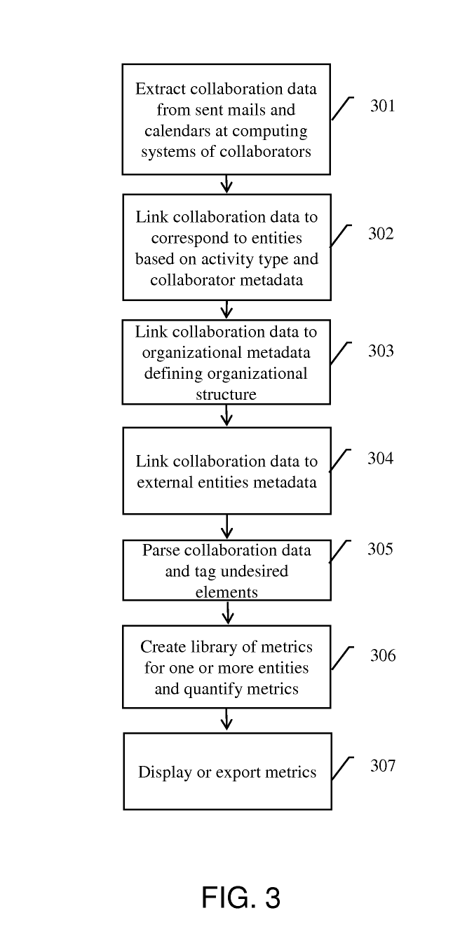

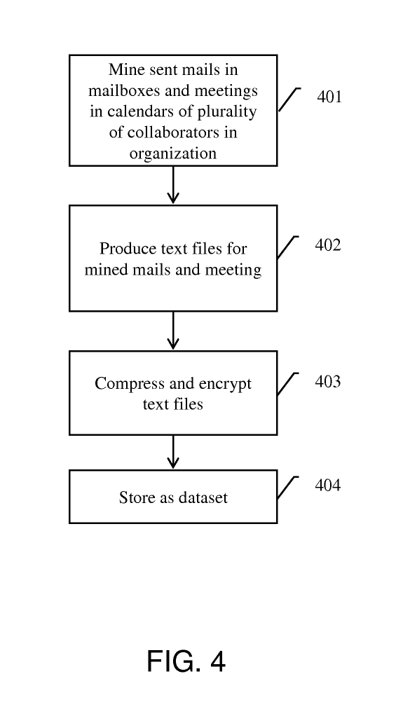

FIG. 3 illustrates a method for deriving entities and metrics from collaboration data according to embodiments of the present invention. First, the server 105 extracts collaboration data from sent mails and calendars of the computing systems 102 of the internal collaborators (301). The collaboration data may be extracted directly from the computing systems 102 or from the server 104 hosting the email, inter-organizational data sharing, or other cloud services. The collaboration data is stored in a database as a dataset. For example, the collaboration data is collected from emails, calendars, phone calls, chats, document sharing, etc. In this embodiment, the collaboration data is in the basic transactional form and may not be conducive to analysis, and thus requires further processing. FIG. 4 is a flowchart illustrating in more detail the extraction of collaboration data from the mails and calendars of the collaborators in the organization, according to embodiments of the present invention. The server 105 mines the sent mails in the mailboxes and the meetings on the calendars the plurality of computing systems 102 of the plurality of collaborators (401). In this embodiment, only the headers of each sent mail are extracted for privacy and data security purposes. Example header data that are extracted includes, but are not limited to: identity of the sender; identity of each recipient; subject line; and date and time sent. For the meetings on a calendar, the data that is extracted includes, but is not limited to: identity of the collaborator on whose calendar is meeting is found; identity of each attendee; duration of the meeting; identity of the meeting organizer; and location of the meeting. Text files are then produced by the server 105 for the mined mails and meetings (402). In this embodiment, one folder is created for each mailbox mined. Each mail and meeting is disassembled into components for easier storage in the text files. The text files are then compressed and encrypted (403) and stored as the dataset in a database (404). Other methods of storing the mined mails and meetings may be used without departing from the spirit and scope of the present invention.

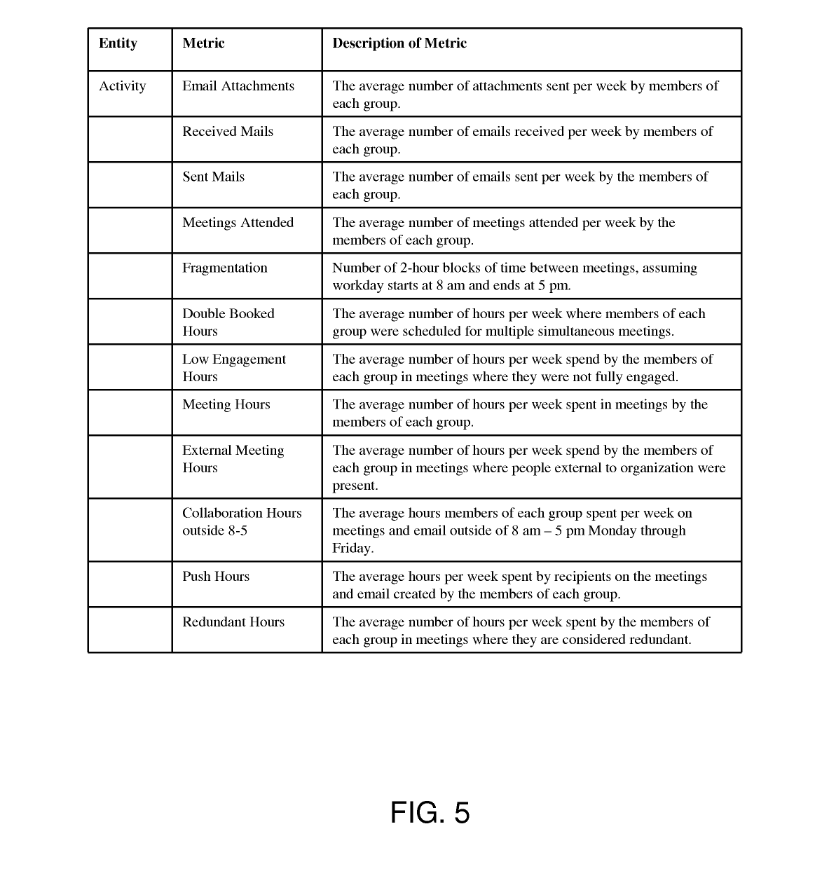

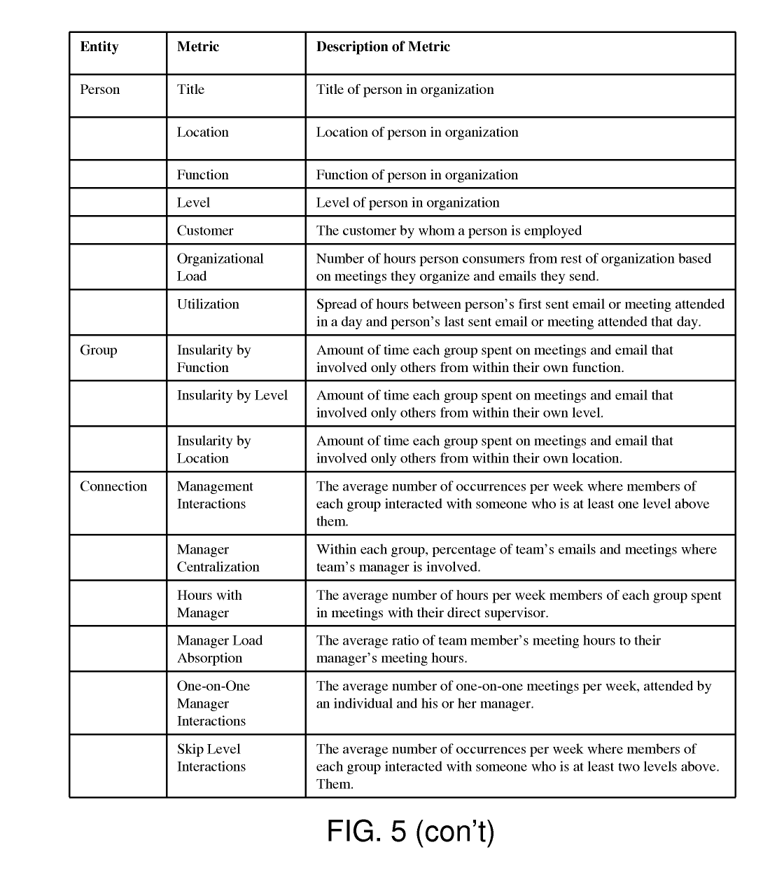

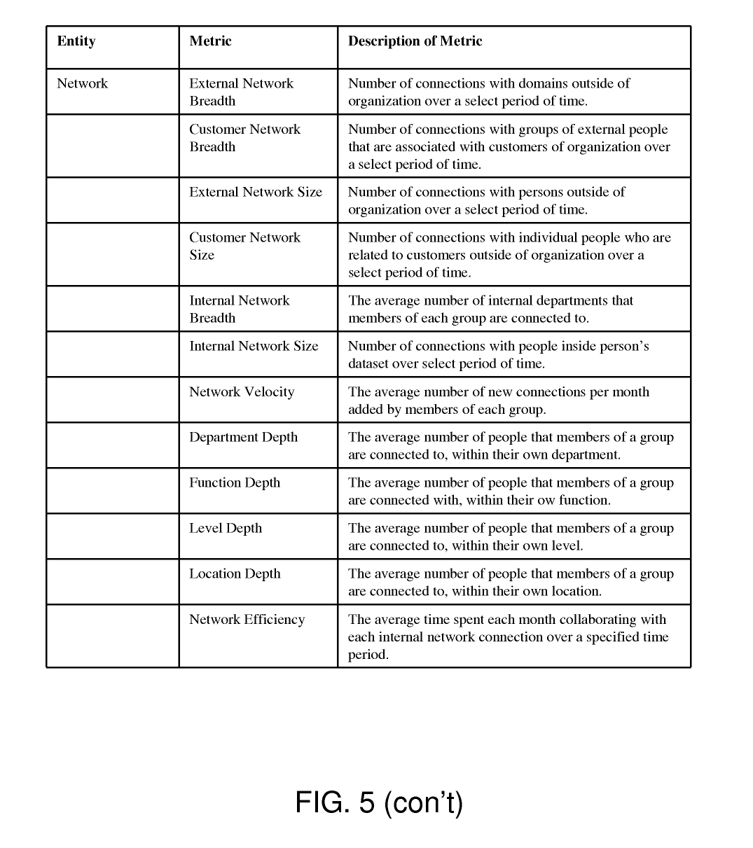

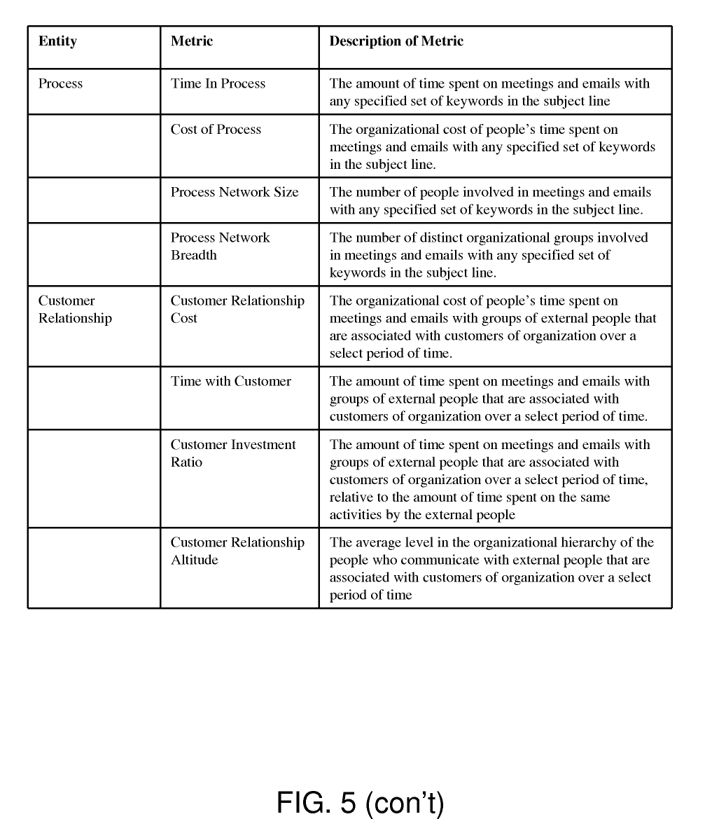

Returning to FIG. 3, the server 105 then links the collaboration data to correspond to entities based on the activity type and the collaborator metadata (302). The “entities” defined in the system include, but are not limited to, an activity (email, meeting, chat, call, etc.), person, group (of people), connection (connections between people based on types and quantity of collaboration activity), network (collection of connections based on types and quantity of collaboration activity), and process (internal collaborator engagement in collaboration activities based on keywords, type, quantity, groups and networks in the collaboration activity). The entities are defined in order to standardize the collaboration data and to organize the collaboration data in a way that allows the evaluation of specific behaviors. The entities are further described below with reference to FIG. 5. The server 105 further links the collaboration data to organizational metadata which defines the organizational structure (303). The organizational metadata may be derived from an organizational chart, a human resources information system, a payroll system, and any other systems containing information relevant to the organizational structure. Examples of organizational metadata include, but are not limited to, the identity of individuals in a specific function (e.g. sales function), a location (e.g. in the Seattle office), title (e.g. Manager). In this embodiment, email and meeting activity records, extracted in step 301, are linked by email address with the organizational metadata about the internal collaborators involved in these activities.

The server 105 further links the collaboration data to external entity metadata (304). Examples of external entities include, but are not limited to, customers, resellers, and vendors. The external entity metadata may include, but are not limited to, an external collaborator's email address, domain name, company name, or name. External entity metadata may be directly provided or derived from email and calendar activities of internal collaborators. Further, linking the collaboration data to external entity metadata can be used to link external collaborators for which metadata exists with other external collaborators for which metadata does not exist. For example, an email to an internal collaborator from an external collaborator for which metadata exists may include a “carbon copy” (cc) to an external collaborator for which metadata does not exist. If both external collaborator's email addresses are of the same domain, then metadata for the cc'ed external collaborator may be defined to associate both external collaborators to the same external entity. In this embodiment, email and meeting activity records, extracted in step 301, are linked by email address with the external entity metadata about the external collaborators involved in the email and meeting activities.

The server 105 further parses the collaboration data and tags undesired elements (305). The tagging of undesired elements is based on the characteristics of the activities, such as keywords, participants, meeting duration, meeting overlaps, attendee status, etc. In this embodiment, the tagging includes a meeting de-duplication process and an attendee de-duplication process. The meeting de-duplication process identifies overlapping meetings, i.e., where an attendee is scheduled to attend two or more meetings with overlapping times. In this embodiment, the meeting time for each meeting is adjusted such that the adjusted time durations (i.e., the meeting time to be assigned) does not exceed the actual time duration for the meetings. For example, assume that A and B is scheduled to meet from 1 pm to 2 pm, but A is also scheduled to meet with C from 1:30 pm to 2 pm. The total meeting time to be allocated here is 1 hour. For A, 0.5 hours of the meeting time would be allocated to the meeting with B, and 0.5 hours would be allocated to the meeting with C. B would be allocated 1 hour, and C would be allocated 0.5 hours. The attendee de-duplication process identifies multiple responses to a meeting invitation from the same attendee, which may cause this attendee to be listed twice for the same meeting. In this embodiment, the later response by the attendee is favored, and the earlier response is removed. The tagging for meetings may further include an hours adjustment process and a process to remove non-meeting appointments. In the hours adjustment process, hours for certain meetings are adjusted to more accurately reflect the collaboration time. For example, all-day, all-week, or recurring meetings are adjusted to be no more than a work day length per day, such as 8 hours of collaboration time a day. This is to avoid a 24 hour time allocation. In the process to remove non-meeting appointments, meetings on the calendar which are likely non-meetings are removed from the dataset. For example, meetings tagged as vacations, doctor's appointments, pick up kids, etc. are removed as they are not actual meetings. Meetings with zero attendees may also be removed as non-meeting appointments. A machine-learning model may be used to predict whether a meeting on a calendar is “real” or a non-meeting. The “cleaned” meetings are stored back into the database.

The server 105 then creates a library of metrics for one or more of the entities and quantifies the metrics (306). These metrics are used to quantify specific behaviors or describe the entities. FIG. 5 illustrates metrics and their descriptions that may be configured for the entities according to embodiments of the present invention. Illustrated in FIG. 5 are the following entities: Activity; Person; Group; Connection; Network; Process; and Customer Relationships. The Activity, Person, and Group entities may be considered “base entities”, configured to define collaboration activities engaged in by collaborators, which may be aligned in various ways to evaluate collaborator behavior at a group level. As illustrated in FIG. 5, in this embodiment, the metrics configured for the Activity entity may include, but not be limited to, one or more of the following: Email Attachments; Received Mails; Sent Mails; Meetings Attended; Fragmentation; Double Booked Hours; Low Engagement Hours; Meeting Hours; External Meeting Hours; Collaboration Hours outside 8-5; Push Hours; and Redundant Hours. The metrics configured for the Person entity may include, but not be limited to, one or more of the following: Title; Location; Function; Level; Customer; Organizational Load; and Utilization. The metrics configured for the Group entity may include, but not be limited to, one or more of the following: Insularity by Function; Insularity by Level; and Insularity by Location. These metrics may be used in any combination in the evaluation and analysis of the Activity, Person, and Group entities. Sample questions that may be addressed through the evaluation and analysis of the Activity, Person, and Group entities and their metrics may include, but are not limited to: what is the total collaboration time of person X; how much time does the Marketing Team spend in low engagement meetings; how much time does the organization spend in collaboration outside of normal working hours; are the schedules of the collaborators overly fragmented; and do we have too many management layers in the meetings.

A Connection entity may be derived from the base entities, configured to capture the connections people establish through engaging in collaboration activities with other people. People can be aligned in various ways to evaluate the connectivity between groups (e.g. Marketing and Product Development, Sales and Customer, Manager and Direct Report, etc.). As illustrated in FIG. 5, in this embodiment, the metrics configured for the Connection entity include, but not be limited to, one or more of the following: Management Interactions; Manager Centralization; Hours with Manager; Manager Load Absorption; One-on-One Manager Interactions; and Skip Level Interactions. These metrics may be used in any combination in the evaluation and analysis of the Connection entity. Sample questions that may be addressed through the evaluation and analysis of the Connection entity and its metrics may include, but are not limited to: how much time does Manager X spend collaborating with the team; are managers spending one-on-one time with their direct reports; how much time do sales people spend in meetings with high value customers; how healthy is the connection between Marketing and Product Development; are the top performers spending enough time with upper management; and are we nurturing innovation by ensuring separate units and functions are collaborating.

A Network entity may be derived from the base entities and the Connection entities, configured to capture the collection of connections within an organization and/or any group of people. As illustrated in FIG. 5, in this embodiment, the metrics configured for the Network entity include, but not be limited to, one or more of the following: External Network Breadth; Customer Network Breadth; External Network Size; Customer Network Size; Internal Network Breadth; Internal Network Size; Network Velocity; Department Depth; Function Depth; Level Depth; Location Depth; and Network Efficiency. These metrics may be used in any combination in the evaluation and analysis of the Network entity. Sample questions that may be addressed through the evaluation and analysis of the Network entity and its metrics may include, but are not limited to: what does the organizational network look like; how many people connect the sales organization to the most important customer; who are the key connectors between R&D and Sales; where in the organization do we have structural holes; how quickly are new people integrating within the organization; are employees successful in building networks; and how many internal teams are involved in sales to key customers.

A Process entity may be derived from the base entities, the Connection entities, and the Network entities, configured to capture collaborator engagement in collaboration activities and connections to fulfill a specific business process. As illustrated in FIG. 5, in this embodiment, the metrics configured for the Process entity include, but not be limited to, one or more of the following: Time in Process, Cost of Process, Process Network Size, Process Network Breadth. These metrics may be used in any combination in the evaluation and analysis of the Process entity. Sample questions that may be addressed through the evaluation and analysis of the Process entity and its metrics may include, but are not limited to: what are the most time consuming processes in the organization and are their efficiency levels; which are the key groups outside of Finance in driving quarterly budgeting; what is the true cost of product development; how long does it take to close the most valuable customer; what should be the real budget for the next product in development.

A Customer entity may be derived from the base entities, the Connection entities, the Network entities, and the Process entities, configured to capture collaborator engagement in collaboration activities and connections to external people who are customers of the organization. As illustrated in FIG. 5, in this embodiment, the metrics configured for the Customer entity include, but not be limited to, one or more of the following: Customer Relationship Cost; Time With Customer; Customer Relationship Altitude; and Customer Investment Ratio. Sample questions that may be addressed through the evaluation and analysis of the Customer entity and its metrics may include, but are not limited to: How much does it cost to maintain each customer relationship; what types of people are most important to maintaining profitable customer relationships; what activities correlate with customer satisfaction; and what activities are predictive of customer purchase behavior.

In this embodiment, the Person and/or Group entities may be combined with performance indicators, configured to capture the activities and processes that result in specific business outcomes, such as booked sales, quota attainment, performance ratings, and consultant utilization. This combination with the performance indicators may then be used in the evaluation and analysis of any one or more of the entities above. Sample questions that may be addressed through this evaluation and analysis may include, but are not limited to: what is the collaboration behavior of the top performing sales people; which collaboration metrics are correlated with revenue risk and what are the regions with highest risk of meeting their revenue target; and what behaviors should be the focus in developing the organization as a whole.

Although FIG. 5 illustrates the metrics corresponding to specific entities, one or more of the metrics may be configured to correspond to multiple entities. Other metrics may also be defined for the purpose of quantifying specific behaviors or to describe the entities without departing from the spirit and scope of the present invention.

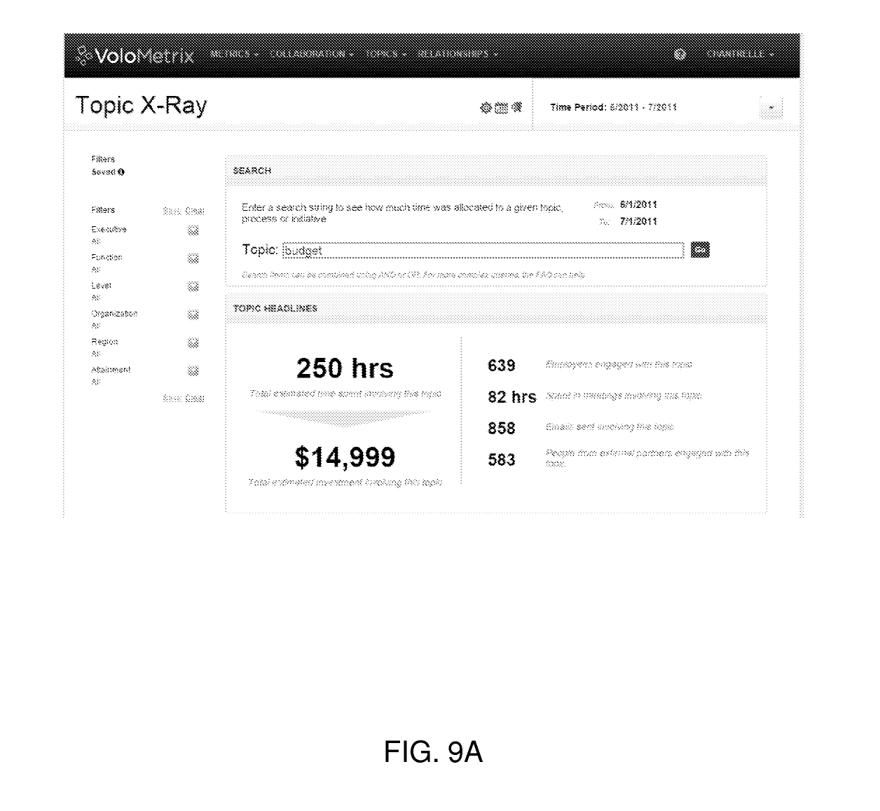

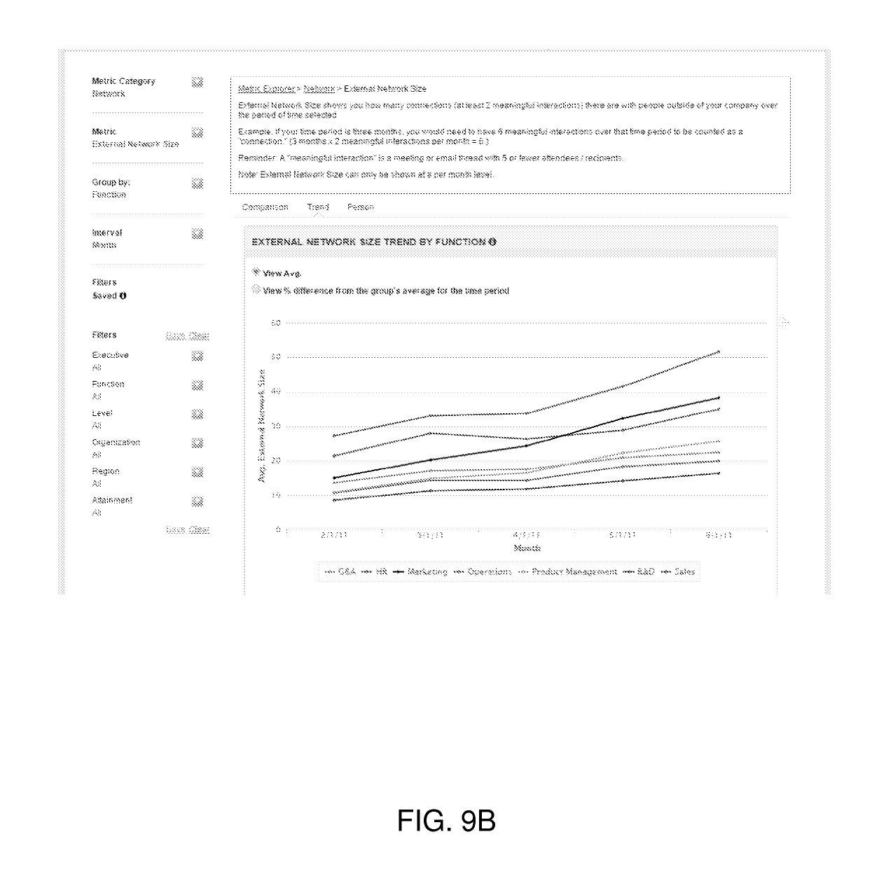

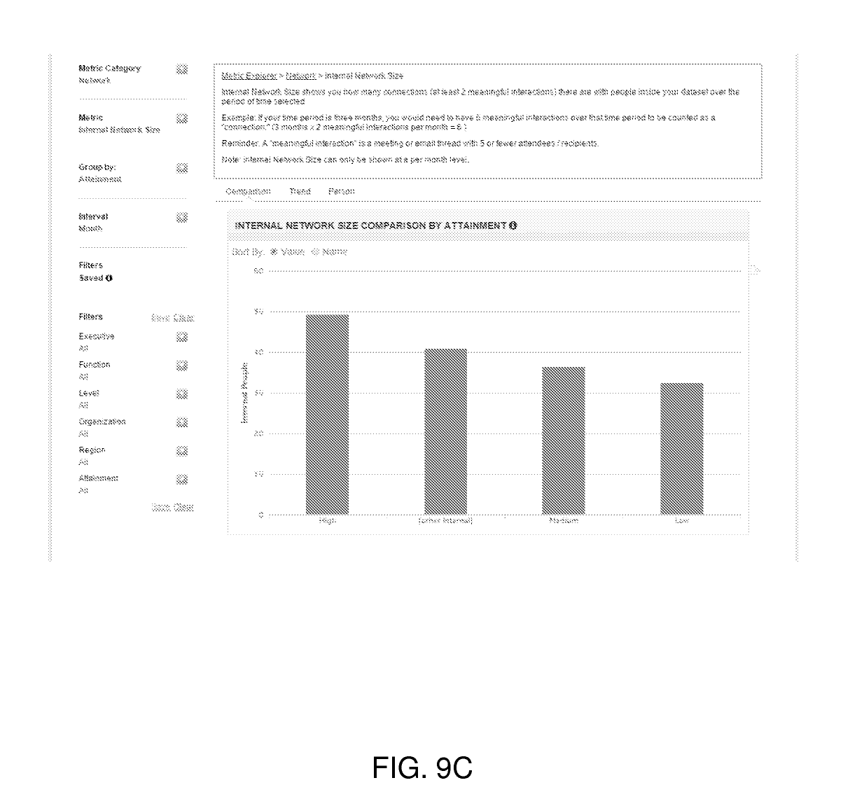

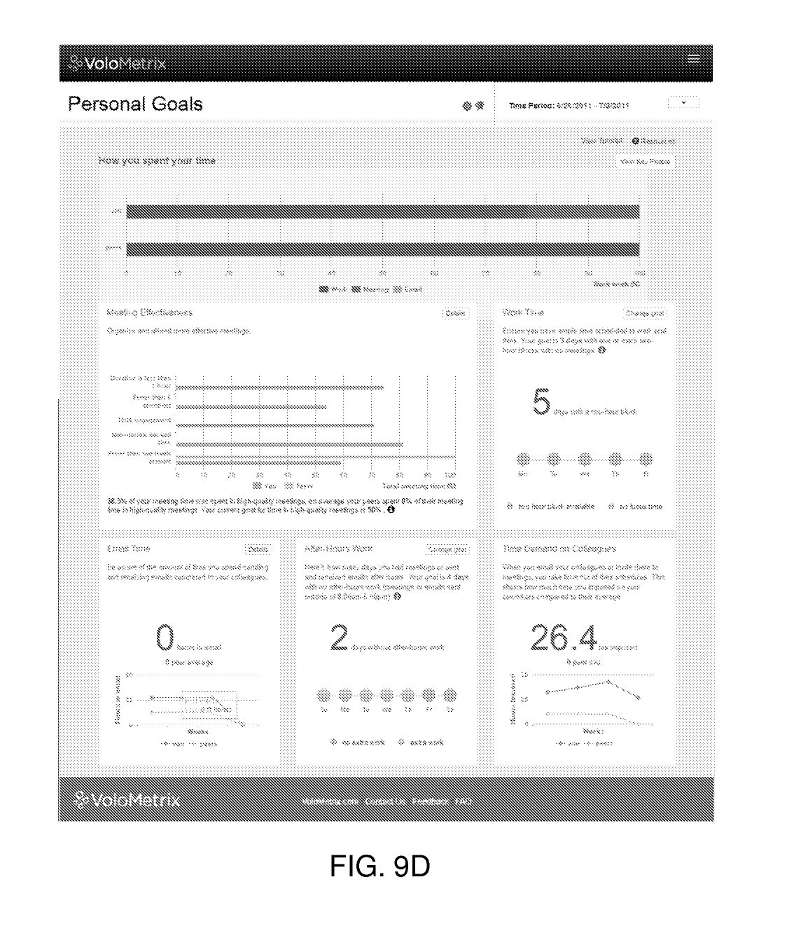

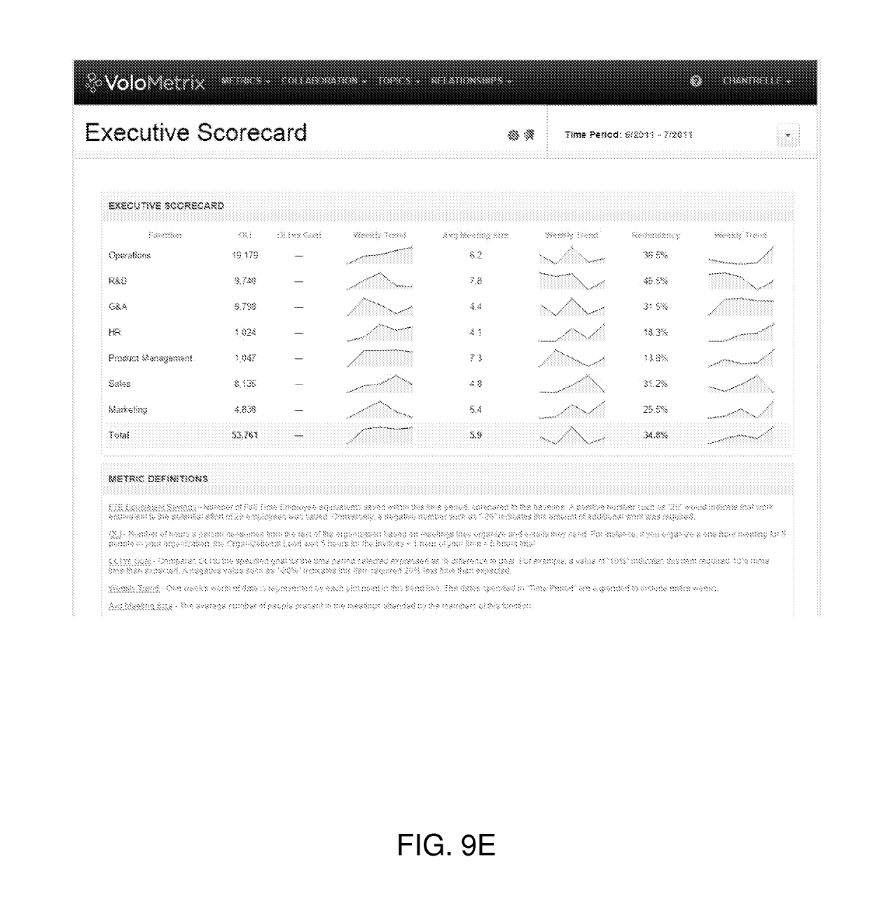

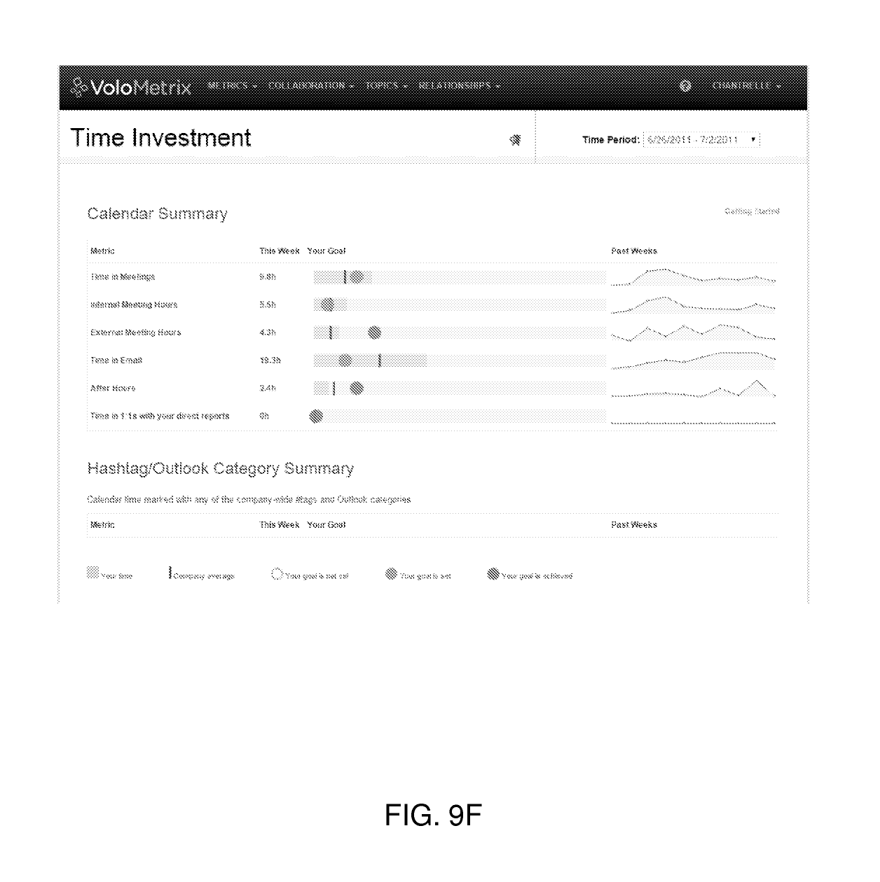

Returning to FIG. 3, the server 105 then displays or exports one or more of the metrics via a display interface (307). For example, the server 105 may display menus of pre-selected sets of metrics, and the user may select a specific metric or combination of metrics, or a user may select one or more parameters for sorting, filtering, and/or grouping the metrics. FIGS. 9A-9F illustrate example displays of the metrics according to embodiments of the present invention. FIG. 9A illustrates a display of process metrics including Process Cost and Time in Process. FIG. 9B illustrates a display of the External Network Size metric over time, grouped by business function. FIG. 9C illustrates a display of the Internal Network Size metric, grouped by the outcome measure of quota attainment for salespeople. FIG. 9D illustrates a display of metrics for an individual to understand personal time use, including Time in Meetings, Time in Email, Time Fragmentation, After-Hours Work and Organizational Load Index. FIG. 9E illustrates a display of metrics for an executive to track progress toward an organizational goal, including Organizational Load Index, Average Meetings Size and Manager Redundancy. FIG. 9F illustrates a display of metrics for an individual to understand personal time use, including Time in Meetings, Internal Meeting Hours, External Meeting Hours, Time In Email, After Hours Work, and Time in 1:1 Meetings. In this manner, the user can data mine the metrics to derive insights into specific behaviors.

The server 105 can further display the metrics related to the entities in combination with outcome data, such as sales dollars, sales quota attainment, customer services scores, net promoter score, etc. Once the outcome data is available, the server 105 optionally can use the entities and metrics to build a predictive model which correlates the entities and metrics with the business outcomes. Such models can be applied to assess the likelihood of desired or undesired events occurring in the future and allow management to run intervention and take action to drive to desired results (e.g. external network size, internal centrality and time spent with customers for each sales person have a high positive correlation to sales quota attainment in company XYZ for the last 3 quarters). For example, when applying the predictive model on the first two months of the last quarter, recent behavior of the sales team in the South region may be identified which indicates that the team will be highly unlikely to reach their sales goals. The country sales manager receives notification of this and reaches out to the South region to help with resolution and additional resources.) Once an organization diagnoses a desired or undesired behavior using the entities and metrics, the organization can define programs for continuous improvement with near real-time monitory and feedback loops. Additionally, the organization's goals can be driven down to the individual level allowing visibility into its own performance and promoting change through, for example, gamification and incentive programs. For example, analysis may show that the highest performers spend 20% less time than a certain collaborator in unproductive meetings. Incentives may then be given to the collaborator to decrease time in unproductive meetings.

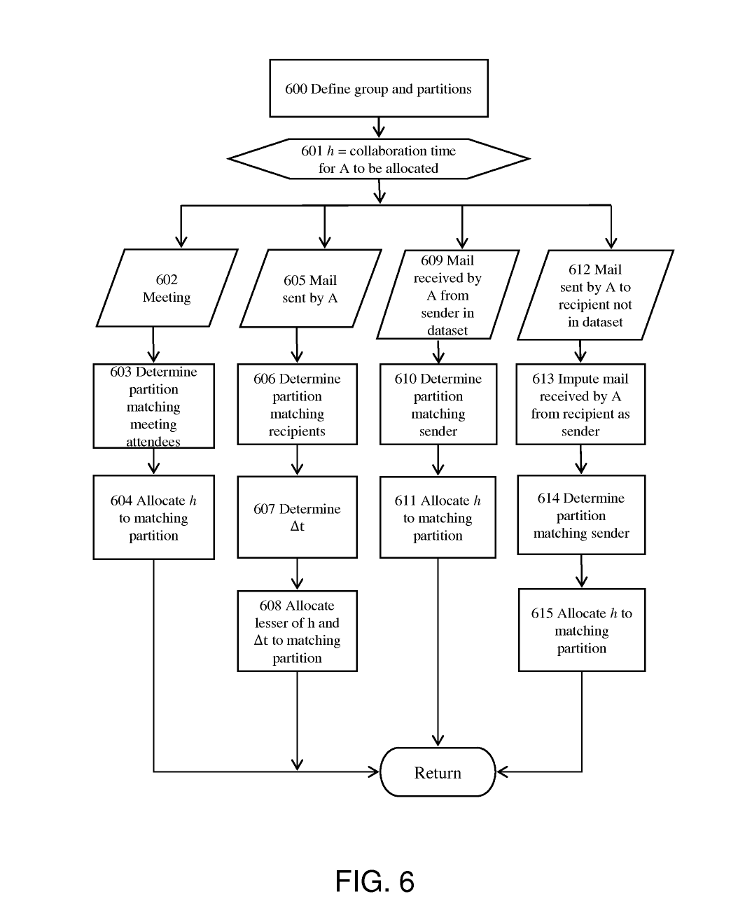

To quantity many of the metrics, it is necessary to assign time to collaboration activities, persons, and groups. FIGS. 6-8 illustrate methods for time assignment to be used in the quantification of metrics according to embodiments of the present invention. The methods for time assignment are further set forth in U.S. patent application Ser. No. 14/292,753, filed on May 30, 2014. U.S. patent application Ser. No. 14/292,753 is incorporate herein by reference in its entirety.

Time Allocation

In one approach according to the present invention, collaboration time for each member of a group is assigned by the server 105 using a time allocation method. FIG. 6 is a flowchart illustrating the time allocation method according to embodiments of the present invention. A group of collaborators and a plurality of partitions are defined by the server 105(600). A group is defined by filtering the attributes associated with a plurality of collaborators. It is for this group whose time is being allocated. A single person “group” is possible. For example, a group may be defined as collaborators in a specific region or a particular business unit within the organization 101. Partitions representing different types of collaborations involving the group are also defined. For example, partitions may be by “internal/external”, where “internal” represents collaborators within the organization 101 and “external” represents collaborators external to the organization 101. In other examples, partitions may be by function or by domain. In the internal/external scenario, example partitions may be:
only involves collaborators from the group;
involves internal collaborators not from the group and no external collaborators;
involves internal collaborators not from the group and external collaborators; and
involves no internal collaborators not from the group and some external collaborators.
   In the by function scenario, example partitions may be:
only involves collaborators from the group;
Function A;
Function B; . . . and
external collaborators involved.
   In the by domain scenario, example partitions may be:
doesn't involve external collaborators;
partner1.com; and
partner2.com; . . .
   In each scenario, the same amount of total time is allocated across the partitions.

In this embodiment, the following basic time allocation rules are used (where A is a collaborator from the group whose time is being allocated):
When A attends a meeting, A's time will be allocated based on the identities of the other attendees. (In this embodiment, the identity of the meeting organizer is not considered.
When A sends a mail, A's time will be allocated based on the identities of the recipients. A recipient includes those identified in the cc and bcc fields.
When A receives a mail, A's time will be allocated based on the identity of the sender. (In this embodiment, the identities of the other recipients are not considered.)

Assume that h is the collaboration time for A. The value of h may vary depending on the collaboration activity type, and may be tunable. When the collaboration activity type is a meeting (602), h=time duration of the meeting to be allocated, possibly adjusted as described above with reference to step 305 (FIG. 3). The server 105 determines the partition that matches the meeting attendees (other than A) (603). Then, h is allocated to the matching partition (604).

When the collaboration activity type is a mail sent by A (605), the server 105 determines the partition that matches the recipient(s) of the mail (606). The server 105 also determines the time between this mail and any mail sent by A immediately prior (Δt) (607). The server 105 then allocates the lesser of h and Δt to the matching partition (608). In this way, double-counting time for multiple emails can be avoided. For example, assume that 5 minutes is the amount of time to be allocated for each sent mail. Assume also that A sends a first mail at 8:00 am and a second mail at 8:02 am. For the first mail, 5 minutes of A's time is allocated, while the second mail is allocated 2 minutes. This ensures that the time allocated for mails sent within a certain time period does not exceed the length of the time period. Further, in this embodiment, no time is allocated for any mail sent by A where the only recipient is A.

For mail received by A from a sender in the dataset (609), A's collaboration time as a mail recipient would be captured when this sender's sent mails are processed. The server 105 determines the partition matching the sender (610), and h is then allocated to the matching partition (611). However, when a sender is not in the dataset, collaboration time for A as a mail recipient cannot be captured directly since this sender's mailbox is not included in the dataset. To capture collaboration time for mail received by A from a sender not in the dataset (612), A is assumed to receive mail from recipients not in the dataset in response to a mail sent to the recipient by A. In other words, A is imputed to receive mail from this recipient as a sender (613). The server 105 determines the partition that matches the (imputed) sender (614) and allocates h to the matching partition (615).

Steps 601-615 are repeated for each member of the group.

Consider the following example in which each collaborator is associated with attributes that includes a Function and a Region, and a Group is defined as {Function=Sales and Region=West}. Assume a plurality of collaborators includes the following people with their corresponding attributes:
Alice {Sales, West}
Bob {Sales, West}
Charlie {Sales, East}
Dave {HR, East}
Eddie {OPS, Central} [no mailbox]
Fred {domain1.com}
Gene {domain2.com}
Heidi {domain2.com}
Iris {domain2.com}.
   Here, the Group includes Alice and Bob. Charlie, Dave, and Eddie are internal collaborators who are not from the Group. Fred, Gene, Heidi and Iris are external collaborators. Assume that the following partitions are defined by interactions between groups of people:
“Within-group”: only involves collaborators from the Group;
“Other Internal”: involves internal collaborators not from the Group and no external collaborators;
“Other Internal +External”: involves internal collaborators not from the Group and external collaborators; and
“External Only”: involves no internal collaborators not from the Group but some external collaborators.
   For a 1-hour meeting with the above attendees (602), the meeting attendees are matched to the “Other Internal+External” partition (603). Two hours (1 hour for Alice and 1 hour for Bob) are then allocated to the Other Internal+External partition (604).

For the same 1-hour meeting, assume the following partitions are defined by function:
“Within-group”: only involves collaborators from the Group;
“Other Internal”: involves internal collaborators not from the Group; if there are m non-group member internal attendees, with m₁ in function 1, . . . mₖ in function k, then allocate h*(m₁/m) time to function 1, . . . , and h*(mₖ/m) time to function k; and
if there only external attendees, then h is allocated to the External Only partition.
   Since there are three non-Group internal attendees (Charlie, Dave, and Eddie), the 1 hour is allocated to the Other Internal partition by dividing it among the functions as follows:
Sales: ⅔ hour, 1 meeting (for Charlie)
HR: ⅔ hour, 1 meeting (For Dave)
OPS: ⅔ hour, 1 meeting (For Eddie)

For the same 1-hour meeting, assume the following partitions are defined by region:
“Within-group”: only involves attendees from the Group;
“Other Internal”: if there are m non-group member internal attendees, with m₁ in region 1, . . . mₖ in region k, then allocate h*(m₁/m) time to region 1, . . . , and h*(mₖ/m) time to region k; and
“External Only”: only external attendees.
   Since there are three non-Group internal attendees (Charlie, Dave, and Eddie), the 1 hour is allocated to the Other Internal partition by dividing it among the regions as follows:
East: ⅔ hour, 1 meeting (for Charlie and Dave)
Central: ⅓ hour, 1 meeting (for Eddie)

For the same 1-hour meeting, assume the following partitions are defined by external partner:
“Internal”: only involves collaborators from the Group;
“External”: if there are m external attendees, with m₁ from Domain 1, . . . mₖ from Domain k, then allocate h*(m₁/m) time to Domain 1, . . . , and h*(mₖ/m) time to Domain k; and
   Since there are four collaborators at Domains 1 and 2, the 1 hour is allocated to the External partition by dividing it among the domains as follows:
Domain 1: ¼ hour, 1 meeting (for Fred)
Domain 2: ¾ hour, 1 meeting (for Gene, Heidi, and Iris)

Assume that Alice sends a mail to the above collaborators. In this example, 5 minutes is allocated for each sent mail and 2.5 minutes for each received mail. For the above partitions defined by interactions between groups of people, collaboration time would be allocated as follows:
For Alice, this is a sent mail (605), so 5 minutes is allocated to “Other Internal+External partition (607-608);
For Bob, this is a received mail from a sender (Alice) in the dataset (609), so 2.5 minutes are allocated to the “Within-group” partition (610-611);
Eddie has no mailbox and is thus a recipient not in the dataset (612). Alice is imputed to receive a mail from Eddie (613), and 2.5 minutes are allocated to the “Other internal” partition (614-615);
Fred, Gene, Heidi, and Iris are also recipients not in the dataset (612). Alice is imputed to receive a mail from each of them (613), and 2.5 minutes for each of them are allocated to the “External only” partition (614-615).
   This yields a total of 20 minutes of collaboration time for the Group.

For the same email sent by Alice, assume the same partitions defined by function above. Since there are three non-Group internal attendees (Charlie, Dave, and Eddie), the 5 minutes are allocated to the Other Internal partition (610-611) by dividing it among the functions as follows:
Sales: 5*⅓ minutes, 1 mail (for Charlie)
HR: 5*⅓ minutes, 1 mail (for Dave)
OPS: 5*⅓ minutes, 1 mail (for Eddie)
   In addition, 2.5 minutes are allocated to the Within-group partition for Bob as the recipient in the dataset (610-611). 2.5 minutes are allocated to OPS in the Other Internal partition, imputed for Eddie as a recipient not in the dataset (613-615). 2.5*4 minutes are allocated to the External Only partition, imputed for Fred, Gene, Heidi, and Iris as recipients not in the dataset (613-615).

For the same email sent by Alice, assume the same partitions defined by region above. Since there are three non-Group internal recipients (Charlie, Dave, and Eddie), the 5 minutes are allocated to the Other Internal partition (610-611) by dividing it among the regions as follows:
East: 2*(5*⅓) minutes, 1 mail (for Charlie and Dave)
Central: 5*⅓ minutes, 1 mail (for Eddie)
   In addition, 2.5 minutes are allocated to the Within-group partition for Bob as the recipient in the dataset (606-608). 2.5 minutes are allocated to OPS in the Other Internal partition, imputed for Eddie as a recipient not in the dataset (613-615). 2.5*4 minutes are allocated to the External Only partition, imputed for Fred, Gene, Heidi and Iris as recipients not in the dataset (613-615).

For the same email sent by Alice, assume the same partitions defined by external partner above. Since there are four external recipients (Fred, Gene, Heidi, and Iris), the 5 minutes are allocated to the External partition (613-615) by dividing it among the domains as follows:
Domain 1: 5*¼ minutes, 1 mail (for Fred)
Domain 2: 3*(5*¼) minutes, 1 mail (for Gene, Heidi, and Iris)
   In addition, 2.5 minutes are allocated to the Internal partition for Bob as the recipient in the dataset (606-608). 2.5 minutes are allocated to the Internal partition for an imputed mail from Eddie to Alice (613-615). 2.5 minutes are allocated to Domain 1 in the External partition for an imputed mail received by Alice from Fred (613-615). 7.5 minutes are allocated to Domain 2 in the External partition for imputed mails received by Alice from Gene, Heidi, and Iris (613-615).

Although embodiments of the time allocation method according to the present invention are described using sent mails and meetings in the above as representative of collaboration activities, other data may also be used, either alone or in combination, without departing from the spirit and scope of the present invention. For example, telephone logs, IM, and any other collaboration means that has a digital footprint may be considered. Further, end-user feedback may also be incorporate, for example, to assist in identifying calendar entries as non-meeting. Also meeting and/or mail time allocated may be further adjusted in other ways, for example, for mails sent by an attendee during a meeting,

Time Spent

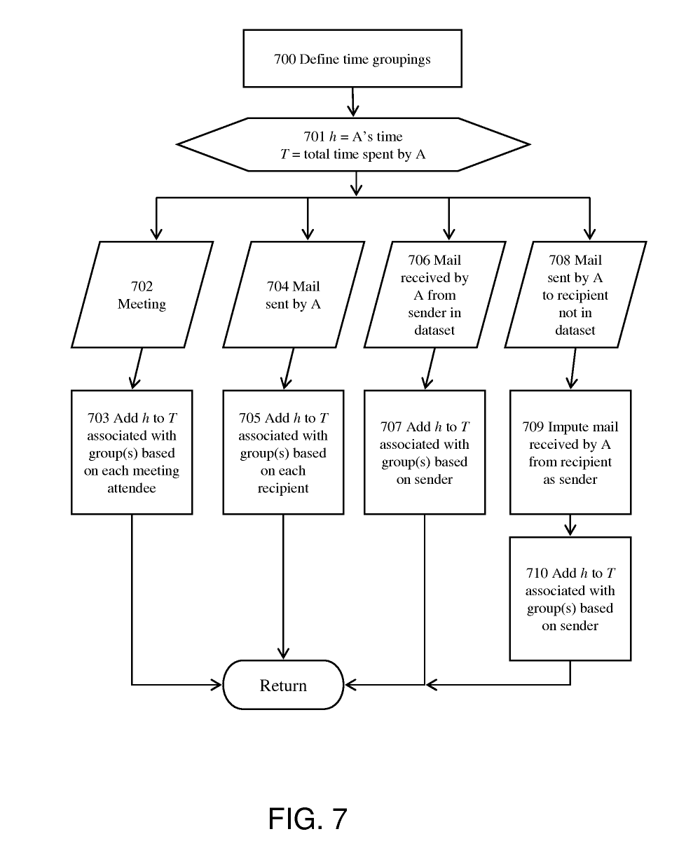

In another approach according to the present invention, collaboration time for each member of a group is assigned using a time spent method, where the total time spent by a collaborator with one or more groups is determined. The time spent method may be used when an organization wishes to determine the total time someone spends with each group. FIG. 7 is a flowchart illustrating the time spent method according to embodiments of the present invention. First, time groupings are defined by the server 105 (700). The time groupings represent how A's spent time will be counted. For example, the groups may be defined by person, function, or domain. Assume that h=A's time, and T=total time spent by A (701). There is a T associated with each group. For each meeting in which A is an attendee (702), h is added to the T's associated with one or more groups based on each meeting attendee (703). For the following example groups, h would be counted as follows:
grouped by person: add h to T associated with each attendee (other than A);
grouped by function: add h to T associated with each distinct internal attendee function; and
grouped by domain: add h to T associated with each distinct external attendee domain.
   For each mail sent by A (704), h is added to the T's associated with one or more groups based on each recipient (705). For the following example groups, h would be counted as follows:
grouped by person: add h to T associated with each recipient;
grouped by function: add h to T associated with each distinct internal recipient function; and
grouped by domain: add h to T associated with each distinct external recipient domain.
   For each mail received by A from a sender in the dataset (706), h is added to the T associated with one or more groups based on the sender (707). For the following example groups, h would be counted as follows:
grouped by person: add h to T associated with the sender;
grouped by function: add h to T associated with the sender's function, if the sender is internal; and
grouped by domain: add h to T associated with the sender's domain, if the sender is external.
   For each mail sent by A to a recipient not in the dataset (708), a mail is imputed to be received by A from the recipient as sender (709), and h is added to the T's associated with one or more groups based on the recipient (710). For the following example groups, h would be counted as follows:
grouped by person: add h to T associated with each recipient;
grouped by function: add h to T associated with each distinct internal recipient function; and
grouped by domain: add h to T associated with each distinct external recipient domain.

Consider again the following collaborators:
Alice {Sales, West}
Bob {Sales, West}
Charlie {Sales, East}
Dave {HR, East}
Eddie {OPS, Central} [no mailbox]
Fred {domain1.com}
Gene {domain2.com}
Heidi {domain2.com}
Iris {domain2.com}.
   For an 1 hour meeting, T is determined as follows (703):
A's spent time grouped by person: 1 hour of time added to the T associated with each of the other attendees;
A's spent time grouped by function: 1 hour is added to each of the T's associated with Sales, HR, and OPS;
A's spent time grouped by region: 1 hour added to each of the T's associated with West, East, and Central;
A's spent time grouped by domain: 1 hour added to each of the T's associated with Domain 1 and Domain 2.
   For the mail sent by Alice (704), T is determined as follows:
A's spent time grouped by person: 5 minutes is added to the T associated with each of the recipients (705); 2.5 minutes are added to each of the T's associated with Eddie, Fred, Gene, Heidi, and Iris for imputed mail received by Alice (709-710);
A's spent time grouped by function: 5 minutes is added to each of the T's associated with Sales and HR (705); 5 minutes added to the T associated with OPS (705); and 2.5 minutes added to the T associated with OPS from the imputed received mail from Eddie (709-710);
A's spent time grouped by region: 5 minutes is added to each of the T's associated with West and East (705); 7.5 minutes added to the T associated with Central from the imputed received mail from Eddie (709-710);
A's spent time grouped by domain: 7.5 minutes added to the T associated with Domain 1 (5 minutes as recipient of mail from Alice (705)+2.5 minutes from the imputed received mail from Eddie (709-710)); 12.5 minutes added to the T associated with Domain 2 (5 minutes as recipient of mail from Alice (705)+2.5*3 minutes from the imputed received mail from Domain 1 (709-710))

Push/Pull

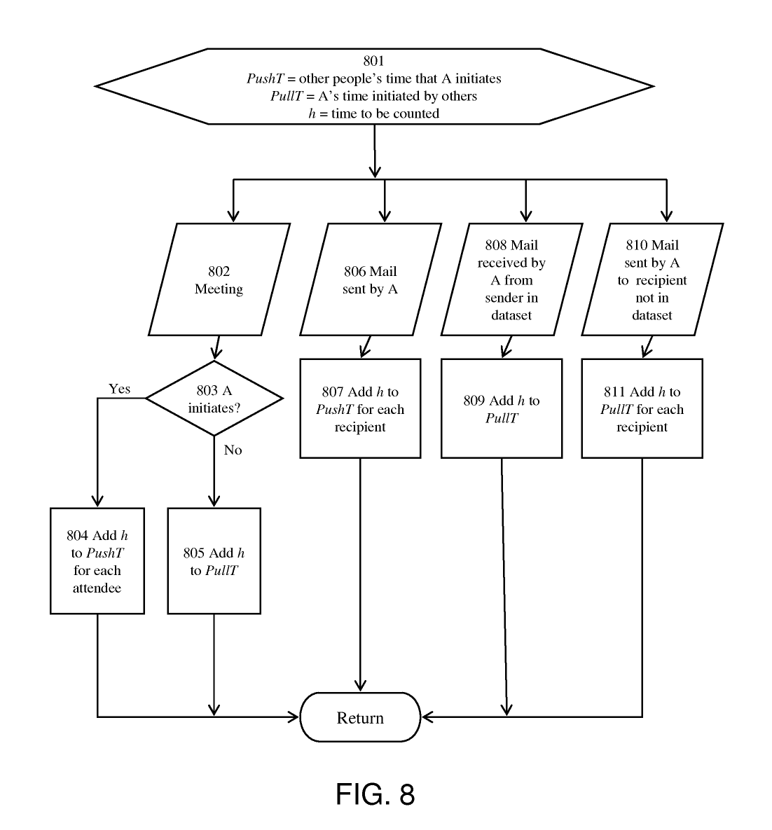

Alternatively or in addition to the above methods, push and pull metrics may be determined, which takes into account the initiator of an interaction. The “Push” counts other people's hours that A initiates, while the “pull” counts A's time initiated by other people. By netting the push and pull counts, one can determine whether someone is a net “pusher” or “pullee”. FIG. 8 is a flowchart illustrating a method for determining the push and pull metrics according to embodiments of the present invention. First, a push number (PushT) and a pull number (PullT) are initialized for A, and h=time to be counted (801). For each meeting (802), if A initiates/organizes the meeting (803), then h is added to the PushT for each attendee (804). If A attends a meeting that someone else initiates/organizes, then h is added to A's PullT. For a mail sent by A (806), h is added to the PushT for each recipient (who is not A) (807). For mail received by A from a sender in the dataset (808), h is added to A's PullT (809). For mail sent by A to recipients not in the dataset (810), h is added to A's PullT for each recipient (811). A's push/pull with a specific group can be determined by considering the attendees/recipients/senders who are in this group.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer usable or compute readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for deriving entities and metrics from collaboration data from a plurality of computing systems, implemented by a processor, comprising:
(a) extracting, by the processor, the collaboration data from sent mails and calendars at the plurality of computing systems of a plurality of collaborators;
(b) linking, by the processor, the collaboration data to correspond to one or more entities based on an activity type and collaborator metadata of the collaboration data;
(c) linking, by the processor, the collaboration data to organizational metadata defining a structure of an organization;
(d) linking, by the processor, the collaboration data to external entities metadata defining one or more entities outside of the organization;
(e) creating, by the processor, a library of metrics for the one or more entities and qualifying the metrics;
(f) displaying the metrics on a display by the processor; and
(g) analyzing, by the processor, the metrics according to instructions received via the display.

2. The method of claim 1, wherein the extracting (a) comprises:
(a1) mining, by the processor, collaboration data from the sent mails in the mailboxes and the meetings in the calendars of the plurality of collaborators; and
(a2) storing the collaboration data as a dataset.

3. The method of claim 1, wherein the linking (b) comprises:
(b1) configuring one or more activity entities for one or more collaboration activities corresponding to the sent mails and the calendars at the plurality of computing systems;
(b2) configuring one or more person entities corresponding to one or more persons involved in the one or more collaboration activities; and
(b3) configuring one or more group entities corresponding to the one or more persons involved in the one or more collaboration activities.

4. The method of claim 3, wherein the linking (b) further comprises:
(b4) configuring one or more connection entities corresponding to one or more connections between persons based on a type and a quantity of the one or more collaboration activities.

5. The method of claim 4, wherein the linking (b) further comprises:
(b5) configuring one or more network entities corresponding to a collection of connections based on the type and the quantity of the one or more collaboration activities.

6. The method of claim 5, wherein the linking (b) further comprises:
(b6) configuring one or more process entities corresponding to collaborator engagement in the one or more collaboration activities.

7. The method of claim 1, wherein the linking (c) comprises:
(c1) deriving the organizational metadata from one or more of the following: an organizational chart, a human resources information system, and a payroll system.

8. The method of claim 1, wherein prior to the creating (e), the method comprises:
(e1) parsing the collaboration data; and
(e2) tagging undesired elements.

9. The method of claim 8, wherein the tagging (e2) comprises:
(e2i) adjusting duplicate or overlapping meetings;
(e2ii) adjusting duplicate or overlapping meeting attendees;
(e2iii) adjusting all day, all-week, or recurring meetings; and
(e2iv) removing non-meeting appointments.

10. The method of claim 3, wherein the creating and quantifying (e) comprises:
(e1) assigning time for the one or more collaboration activities; and
(e2) quantifying the metrics using the time assigned to the one or more collaboration activities.

11. A computer readable medium comprising computer readable program code embodied therein, wherein when executed by a processor causes the processor to:
(a) extract the collaboration data from sent mails and calendars at the plurality of computing systems of a plurality of collaborators;
(b) link the collaboration data to correspond to one or more entities based on an activity type and collaborator metadata of the collaboration data;
(c) link the collaboration data to organizational metadata defining a structure of an organization;
(d) link the collaboration data to external entities metadata defining one or more entities outside of the organization;
(e) create a library of metrics for the one or more entities and qualifying the metrics;
(f) display the metrics on a display; and
(g) analyze the metrics according to instructions received via the display.

12. The medium of claim 11, wherein the link (b) comprises:
(b1) configure one or more activity entities for one or more collaboration activities corresponding to the sent mails and the calendars at the plurality of computing systems;
(b2) configure one or more person entities corresponding to one or more persons involved in the one or more collaboration activities; and
(b3) configure one or more group entities corresponding to the one or more persons involved in the one or more collaboration activities.

13. The medium of claim 12, wherein the link (b) further comprises:
(b4) configure one or more connection entities corresponding to one or more connections between persons based on a type and a quantity of the one or more collaboration activities.

14. The medium of claim 13, wherein the link (b) further comprises:
(b5) configure one or more network entities corresponding to a collection of connections based on the type and the quantity of the one or more collaboration activities.

15. The medium of claim 14, wherein the link (b) further comprises:
(b6) configure one or more process entities corresponding to collaborator engagement in the one or more collaboration activities.

16. A system:
a processor; and
a computer readable medium comprising computer readable program code embodied therein, wherein when executed by the processor causes the processor to:
(a) extract the collaboration data from sent mails and calendars at the plurality of computing systems of a plurality of collaborators;
(b) link the collaboration data to correspond to one or more entities based on an activity type and collaborator metadata of the collaboration data;
(c) link the collaboration data to organizational metadata defining a structure of an organization;
(d) link the collaboration data to external entities metadata defining one or more entities outside of the organization;
(e) create a library of metrics for the one or more entities and qualifying the metrics;
(f) display the metrics on a display; and
(g) analyze the metrics according to instructions received via the display.

17. The system of claim 16, wherein the link (b) comprises:
(b1) configure one or more activity entities for one or more collaboration activities corresponding to the sent mails and the calendars at the plurality of computing systems;
(b2) configure one or more person entities corresponding to one or more persons involved in the one or more collaboration activities; and
(b3) configure one or more group entities corresponding to the one or more persons involved in the one or more collaboration activities.

18. The system of claim 17, wherein the link (b) further comprises:
(b4) configure one or more connection entities corresponding to one or more connections between persons based on a type and a quantity of the one or more collaboration activities.

19. The system of claim 18, wherein the link (b) further comprises:
(b5) configure one or more network entities corresponding to a collection of connections based on the type and the quantity of the one or more collaboration activities.

20. The system of claim 19, wherein the link (b) further comprises:
(b6) configure one or more process entities corresponding to collaborator engagement in the one or more collaboration activities.
